(19) United States
(12) Patent Application Publication
(10) Pub. No.: US 2026/0060243 A1
(43) Pub. Date: Mar. 5, 2026

(54) PEST CONTROL COMPOSITION COMPRISING HYDROTROPIC SALT

(71) Applicant: THE PROCTER & GAMBLE COMPANY, Cincinnati, OH (US)

(72) Inventors: Sean Michael RENOCK, Loveland, OH (US); Allison Lynn EDWARDS, Mason, OH (US); Luke Ryan BRAKE, Morrow, OH (US); Michael David O'Young MUI, Mason, OH (US); Travis Kyle HODGDON, Cincinnati, OH (US)

(21) Appl. No.: 19/259,414

(22) Filed: Jul. 3, 2025

Related U.S. Application Data
(60) Provisional application No. 63/688,450, filed on Aug. 29, 2024.
(60) Provisional application No. 63/688,448, filed on Aug. 29, 2024.
(60) Provisional application No. 63/782,095, filed on Apr. 2, 2025.
(60) Provisional application No. 63/782,096, filed on Apr. 2, 2025.
(60) Provisional application No. 63/782,097, filed on Apr. 2, 2025.

(51) Int. Cl. A01N 25/30; A01N 25/04; A01N 27/00; A01N 31/02; A01N 35/06; A01N 37/36; A01N 65/06; A01N 65/08; A01N 65/22; A01N 65/24; A01N 65/28; A01N 65/44; A01P 13/00

(52) U.S. Cl. CPC A01N 25/30; A01N 25/04; A01N 27/00; A01N 31/02; A01N 35/06; A01N 37/36; A01N 65/06; A01N 65/08; A01N 65/22; A01N 65/24; A01N 65/28; A01N 65/44; A01P 13/00

(57) ABSTRACT

A pest control composition includes from about 4 wt % to about 10 wt % of sodium lauryl sulfate; one or more C5 to C9 hydrotropic salt; from about 1 wt % to about 10 wt % of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof; and from about 60 wt % to about 95 wt % of water. The pest control composition exhibits a water peak in a ²H spectrum having a width encompassing 90% of the area of the entire water signal of about 50 Hz or more, as determined by the ²H NMR Method.

### CROSS REFERENCE TO RELATED APPLICATIONS

This application claims the benefit, under 35 U.S.C. § 119(c), to U.S. Provisional Application Nos. 63/688,448 filed Aug. 29, 2024; 63/782,095 filed Apr. 2, 2025; 63/688,450 filed Aug. 29, 2024; 63/782,096 filed Apr. 2, 2025; and 63/782,097 filed Apr. 2, 2025, the entire disclosure of which is fully incorporated by reference herein.

### FIELD OF THE INVENTION

The present disclosure relates to a pest control composition and to methods for controlling pests, including plant pests and arthropod pests. More particularly, the disclosure relates to a pest control composition comprising hydrotropic salt that forms an anisotropic lyotropic liquid crystalline microstructure which allows the composition to adhere to and spread on a target surface more effectively.

### BACKGROUND OF THE INVENTION

Herbicides can be categorized as having “pre-emergence” action that prevents germination of weed seeds or kills the emergence seedlings, or “post-emergence” action that kills the unwanted plant as it grows. Post-emergence, non-selective weed control products can be categorized as “systemic” herbicides which are absorbed into plant tissue and translocate throughout the plant to cause systemic phytotoxicity or “contact” herbicides that cause chemical destruction of the protective surface tissue and kill the plant by severe desiccation.

Contact herbicides work by affecting the parts of the plant they come into direct contact with. This allows users to selectively target specific weeds without harming surrounding plants, making it an effective option for managing unwanted vegetation in gardens, lawns, and pathways. Many contact herbicides are designed to act quickly. This rapid action can be particularly beneficial for consumers looking for immediate results in controlling weeds that may be competing with their plants for nutrients, water, and light and in helping to maintain the aesthetic appeal of their lawns and gardens.

While contact herbicides are effective in killing the above-ground portions of plants, they may be less desirable to consumers seeking to inhibit or eliminate below-ground plant tissue growth. Furthermore, applying traditional contact herbicides can be challenging due to the hydrophobic nature of plant surfaces. This hydrophobicity can cause droplets of the herbicide to bead up and roll off rather than spread across the leaf surface. Contact herbicides require direct contact with the target plant tissues to be effective. If the herbicide drips or bounces off, it may not adequately cover the leaves and stems, leading to insufficient contact with the plant and ultimately poor control of the target plant. Further, if these herbicides do not sufficiently adhere to the plant and instead drip off, there is an increased risk of injuring nearby plants. Additionally, contact herbicides can unintentionally damage nearby desirable plants if spray drift occurs, causing harm to non-target plants.

Polymers are known to improve adhesion to a plant and are often used in systemic herbicides to help prevent the herbicide from bouncing/dripping off the plant. Some polymers can encapsulate and slowly release an active over time, allowing for a more controlled and targeted application. Such herbicides may take several days to weeks to show visible results of plant injury. However, many consumers want a contact herbicide that can act fast (i.e., shows visible results in an hour and/or shows significant plant injury within 24 hours). Polymers can also increase the viscosity of herbicide solutions, which may lead to clogging in application devices such as sprayers. This can result in uneven application and reduced efficiency.

There is a need for a pest control composition, such as a contact herbicide, that can effectively adhere to and spread on a target surface yet is still compatible with spray delivery devices.

### SUMMARY OF THE INVENTION

To solve the problems advanced above, the present disclosure provides an aqueous pest control composition that comprises one or more hydrotropic salt, one or more surfactant, and one or more active ingredient. It was surprisingly found that with the addition of one or more hydrotropic salt, a pest control composition can be created which forms a unique anisotropic lyotropic liquid crystalline microstructure that allows the composition to better adhere to and spread on a target surface yet still has rheological properties that are compatible with spraying. It was further surprisingly found that by balancing the ratio of total hydrotropic salt to surfactant and/or active ingredient, a pest control composition could be formed that can effectively damage and/or inhibit the growth of plant foliage and roots yet is still phase stable across a range of temperatures.

Described herein is a pest control composition comprising: (a) from about 4% to about 10% by weight of the pest control composition of sodium lauryl sulfate; (b) one or more C5 to C9 hydrotropic salt; (c) from about 1% to about 10% by weight of the pest control composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof; and (d) from about 60% to about 95% by weight of the pest control composition of water. The pest control composition exhibits a water peak in a ²H spectrum having a width encompassing 90% of the area of the entire water signal of about 50 Hz or more as determined by the ²H NMR Method.

Also described herein is a pest control composition comprising: (a) from about 4% to about 10% by weight of the pest control composition of sodium lauryl sulfate; (b) one or more C5 to C9 hydrotropic salt; (c) geraniol; (d) a mint composition chosen from cornmint, spearmint, peppermint, mint oil, or combinations thereof; and (c) from about 60% to about 95% by weight of the pest control composition of water. The pest control composition has a pH of from about 5.0 to about 6.5. The pest control composition exhibits a water peak in a ²H spectrum having a width encompassing 90% of the area of the entire water signal of about 50 Hz or more as determined by the ²H NMR Method.

Also described herein is a pest control composition comprising: (a) from about 4% to about 10% by weight of the pest control composition of sodium lauryl sulfate; (b) one or more C5 to C9 hydrotropic salt; (c) from about 1% to about 10% by weight of the pest control composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof; (d) from about 1% to about 5% by weight of the pest control composition of a solvent, wherein the solvent is a C1-C4 alcohol; and (e) from about 60% to about 95% by weight of the pest control composition of water. The pest control composition has a pH of from about 5.0 to about 6.5. The pest control composition comprises an anisotropic lyotropic liquid crystalline microstructure.

### BRIEF DESCRIPTION OF THE DRAWINGS

FIG. 1A provides a ²H nuclear magnetic resonance (NMR) spectrum showing the water peak of Sample H, as described herein.

FIG. 1B provides a ²H NMR spectrum showing the water peak of Sample I, as described herein.

FIG. 1C provides a ²H NMR spectrum showing the water peak of Sample J, as described herein.

FIG. 1D provides a ²H NMR spectrum showing the water peak of Sample A, as described herein.

### DETAILED DESCRIPTION OF THE INVENTION

The market for pest control products, including weed control, is expanding due to factors like increased urban housing, changing weather patterns, and a rise in home gardening, as well as a desire for attractive lawns and flower beds. At the same time, consumers are demanding more natural options (preferring products with fewer and more recognizable ingredients) that provide effective pest control comparable to traditional chemical products. However, many current natural pest control products face challenges such as instability in cold temperatures, require consumers to shake them before use, and/or have a cloudy or off-color appearance.

Described herein is a stable aqueous composition for controlling a target pest such as a plant or arthropod. As used herein, “stable” refers to a pest control composition that is a single substantially clear or translucent phase free from visually observable phase separation, creaming or precipitation, where no agitation or mixing is required to use the pest control composition for its application. It was surprisingly found that by adding one or more hydrotropic salts to an aqueous composition comprising one or more surfactants and one or more active ingredients comprising an essential oil (including synthetic analogues thereof and/or constituents thereof), a composition can be created which has a unique surfactant lyotropic liquid crystalline microstructure. In particular, it was found that the pest control composition described herein exhibits a water peak in a ²H spectrum having a width encompassing 90% of the area of the entire water signal of about 50 Hz or more, as determined by the ²H NMR Method, indicating the presence of an anisotropic lyotropic liquid crystalline microstructure. Without being limited by theory, it is believed that the hydrotropic salt(s) help the surfactant to form a unique self-assembled microstructure that creates rheological properties that allows the composition to better adhere to a target surface and helps to create wetting properties that allow the composition to spread over the target surface, which can improve efficacy and/or speed of action of the pest control composition, without the use of a polymer.

Features and benefits of the various embodiments of the present disclosure will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, articles such as “a” and “an” when used herein, are understood to mean one or more of what is claimed or described.

As used herein, “anisotropic lyotropic liquid crystalline microstructure” refers to a self-assembled surfactant aggregate structure comprising a surfactant that exhibits some degree of repeat structural order similar to a solid crystal. This ordering of the anisotropic lyotropic liquid crystalline microstructure includes microcrystalline domains where at least one dimension is short enough to impede, retard, slow, or otherwise alter the rotational orientation of water. The repeat spacing of the anisotropic lyotropic liquid crystalline microstructure is such that within a microcrystalline domain the directors normal to the surfactant aggregate structures are aligned along one dimension (for example in the case of a uniaxial lamellar phase) or two dimensions (in the case of biaxial nematic phases) throughout the microcrystalline domain. This aggregate arrangement results in a small anisotropy of the molecular reorientation of the water molecule which gives rise to quadrupolar splitting of the water peak in a ²H NMR spectrum. Examples of anisotropic lyotropic liquid crystalline microstructures can include structures formed in a lamellar phase (e.g., lamella and multi-lamellar vesicles), hexagonal phase, and combinations thereof.

Deuterium (²H) is an isotope of hydrogen (¹H) and is denoted herein equivalently as either ²H or D. The deuterium isotope is present at a natural abundance of 0.0156%, therefore any water present in a sample that has not been isotopically enriched will naturally have a small percentage of HDO water, where the HDO water molecule comprises one atom of hydrogen (¹H or H), one atom of deuterium (²H or D), and one atom of oxygen (O) along with the major water molecular species H₂O. For the purposes stated herein, we presume the predominant species measured is HDO when referring to the water peak in a deuterium NMR spectrum. (While D₂O gives the same deuterium spectral characteristics as does HDO, because of its negligible natural abundance, its contribution is neglected for the purposes herein.) The deuterium nucleus is quadrupolar and thus will display quadrupolar splitting in an NMR spectrum if the water molecule is within a microcrystalline domain that impedes isotropic molecular reorientation. Depending on the anisotropic lyotropic liquid crystalline microstructure combinations present in a sample, the ²H water peak may present as distinct splitting (quadrupolar splitting or “Pake pattern”), generalized peak broadening, or a combination of a centralized peak accompanied with quadrupolar splitting of peaks about the central peak. The broadening and/or splitting of the water peak in ²H NMR (i.e., a water peak in a ²H spectrum having a width encompassing 90% of the area of the entire water signal of about 50 Hz or more) is an indication that the microstructure includes microcrystalline domains that restrict the free orientational rotation of water molecules. Such domains, for example, exist in lamellar sheets and multi-lamellar vesicles where nanometer scale layers of water are trapped between surfactant bilayers and hexagonal phases where nanometer scale channels of water are trapped between organized rod-like surfactant structures.

As used herein, “contacting” refers to treating, applying, spraying, wetting, soaking, dousing, dipping, immersing, sprinkling, wiping, daubing, spreading, splattering, smearing, etc., any pests such as weeds, portions of weeds, arthropods, etc., desired to be killed, removed, destroyed, defoliated, exterminated, eradicated, eliminated, etc., with the pest control composition described herein.

As used herein, “effective amount” refers to an amount of the pest control composition, which is effective to noticeably kill, remove, destroy, defoliate, exterminate, eradicate, eliminate, etc., pests (e.g., insects, weeds) when those pests are contacted with the pest control composition.

As used herein, the terms “include”, “includes” and “including” are meant to be non-limiting.

As used herein, “isotropic lyotropic liquid crystalline microstructure” refers to a self-assembled surfactant aggregate structure comprising a surfactant that exhibits some degree of repeat microstructural order similar to a solid crystal. This ordering of the isotropic lyotropic liquid crystalline microstructure includes microcrystalline domains where at least one dimension is short enough to impede, retard, slow, or otherwise alter the rotational orientation of water. The repeat spacing of the isotropic lyotropic liquid crystalline microstructure is such that within a microcrystalline domain the directors normal to the surfactant aggregate structures are symmetric in three dimensions (for example in the case of cubic phase) or isotropically oriented in three dimensions (in the case of sponge phase) throughout the microcrystalline domain. This symmetry averages the locally anisotropic molecular reorientation of the water molecule to appear isotropic in a ²H NMR spectrum. Examples of isotropic lyotropic liquid crystalline microstructures can include structures formed in a micellar cubic, bi-continuous cubic phase, sponge phase, and combinations thereof. The relatively narrow water peak in ²H NMR (i.e., a water peak in a ²H spectrum having a width encompassing 90% of the area of the entire water signal of less than 50 Hz) is an indication that the microstructure is isotropic.

As used herein, “lyotropic liquid crystalline microstructure” refers to a self-assembled surfactant aggregate structure comprising a surfactant that exhibits some degree of repeat microstructural order similar to a solid crystal. The order may be isotropic or anisotropic. The repeat spacing of the lyotropic liquid crystalline microstructure may be of a length scale, in at least one dimension, short enough that it is capable of impeding, retarding, slowing, or otherwise altering the free molecular reorientation of water. Examples of lyotropic crystalline microstructures can include structures formed in a sponge phase, lamellar phase, cubic phase, hexagonal phase, nematic phase, and combinations thereof. It is to be appreciated that micelle (spherical, worm-like, and/or branched), uni-lamellar vesicles, and microemulsions are isotropic surfactant aggregate structures that are not considered to be lyotropic liquid crystalline microstructures.

As used herein, the term “natural oils” means oils that are derived from plant or algae matter. Natural oils are not based on kerosene or other fossil fuels.

As used herein, “pest control” means the management of a pest species, including any animal, such as insects and other arthropods, plant, or fungus that adversely impacts human activities or the environment, where management includes controlling, killing, eliminating, repelling, or attracting the pest species. Pest control products and compositions may include products and compositions for managing a pest species inside and outside of a building, such as a dwelling or a business, including, but not limited to, areas such as garages, patios, balconies, screened porches, lawns, and/or gardens. Pest control products and compositions may include products and compositions for use in and/or on yards, lawns, gardens, bushes, trees, and/or outdoor plants, as well as for use on or around indoor plants.

The terms “pest control” and “pesticide” are used interchangeably, and it is understood that a composition or an ingredient that has “cidal” activity, e.g., pesticide, insecticide, herbicide, fungicide, may or may not kill and/or eliminate the target pest, e.g., arthropod, insect, plant, weed, or fungus. As used herein, “cide” and “cidal” includes compositions, compounds, components, ingredients, materials, etc., which are effective to kill, remove, destroy, defoliate, exterminate, eradicate, eliminate, etc., a target pest, as well as to retard, regulate, inhibit, prevent, etc., the survival, growth, and/or proliferation of such pest.

As used herein, “substantially free of” or “substantially free from” refers to either the complete absence of an ingredient or a minimal amount thereof merely as impurity or unintended byproduct of another ingredient. A composition that is “substantially free” of/from a component means that the composition comprises less than about 0.05%, or less than about 0.025%, or less than about 0.010%, or less than about 0.005%, or less than about 0.0025%, or less than about 0.001%, all by weight of the composition of the component.

As used herein, “weed” refers to the common meaning of the term as any herbaceous plant, vegetation, foliage, grasses, etc., which is deemed to be undesirable or undesired, for example, as encumbering the ground, as hindering, stifling, overwhelming, etc., the growth of what is deemed desired or more desirable plant, vegetation, foliage, grasses, etc. Weeds for which the composition described herein may be effective against can include one or more of: broadleaf weeds such as dandelions, clover, plantain, chickweed, undesired grasses (e.g., crabgrass), moss, other common weeds, etc.

Volatile Organic Compounds (VOCs) are identified by the U.S. Environmental Protection Agency (EPA) as organic compounds that participate in atmospheric photochemical reactions, with the exception of compounds that have negligible photochemical reactivity. VOCs are generally emitted as gases from certain solids or liquids. EPA regulations define a chemical as “VOC-exempt” if it has vapor pressure of less than 0.1 millimeters of mercury (at 20° C.). If the vapor pressure is unknown, a chemical is defined as “VOC-exempt” if it: a) consists of more than 12 carbon atoms; or b) has a melting point higher than 20° C. and does not sublime (i.e., does not change directly from a solid into a gas without melting).

The compositions of the present disclosure can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All weights, measurements and concentrations herein are measured at 25 degrees Celsius (° C.) and 50% relative humidity, unless otherwise specified.

### Pest Control Composition

The pest control composition described herein may be provided in the form of a concentrated composition, which is mixed with a diluent, e.g., water, prior to use, or a ready-to-use composition, which can be directly applied (e.g., as a spray) to target pests, such as arthropods and weeds, and need not be diluted by a consumer before use. Ready-to-use compositions may be preferred by some consumers because ready-to-use compositions do not require dilution by the consumer, which may be messy, inconvenient, and/or require multiple containers. The pest control composition may contain select ingredients at select levels suitable to be sprayed directly onto pests. The pest control composition may be in the form of a liquid, powder, gel, or a paste that may be applied directly onto the pest. In some aspects, the pest control composition may be an aqueous composition.

The pest control composition disclosed herein may comprise less than about 15 ingredients, or less than about 10 ingredients, or less than about 15 ingredients and greater than about 5 ingredients.

The pest control composition of the present disclosure may comprise renewable components. The pest control composition may comprise from about 1%, or from about 5%, or from about 10%, or from about 20%, or from about 30%, or from about 40%, or from about 50% to about 40%, to about 50%, or to about 60%, or to about 70%, or to about 80%, or to about 90%, or to about 100% by weight of renewable components. The compositions disclosed herein may be at least partially or fully bio-based. As such, the composition can comprise a bio-based carbon content of about 50% to about 100%, or about 70% to about 100%, or about 75% to about 100%, or about 80% to about 100%, or about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may comprise ingredients listed under section 25(b) of the Federal Insecticide, Fungicide, and Rodenticide Act (FIFRA), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient. The compositions disclosed herein may comprise at least one ingredient that is food grade or generally recognized as safe (GRAS). The GRAS ingredient may include any agent listed on the FDA's GRAS list, including direct food additives (see, e.g., US law (sections 201(s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe. The use of food grade or GRAS ingredients can enable the compositions disclosed herein to be used by consumers without rinsing a treated surface after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

### Water

Aqueous liquid compositions are convenient to use because these compositions can be readily applied directly to arthropod pests or weeds, while leaving minimal residue on adjacent surfaces. The pest control compositions may be substantially free of a geologically derived (e.g., petroleum-based) carrier oils, such as mineral oil, and/or a vegetable oil as products containing a carrier oil or vegetable oil may be messy to use and may leave a residue on a treated surface.

The pest control composition may comprise from about 40% to about 99%, or from about 45% to about 98%, by weight of the composition of water. The pest control composition may comprise from about 40% to about 97% water, or from about 60% to about 95%, or from about 50% to about to about 92%, or from about 70% to about to about 90%, or from about 55% to about 83%, or from about 78% to about 80%, all by weight of the composition.

### Active Ingredients

The pest control composition may comprise one or more active ingredients (also referred to herein as actives). Suitable active ingredients may include plant oils/essential oils (including synthetic analogues) and/or constituents thereof (including synthetic analogues). In some aspects, the active ingredient may be a natural oil. Examples of active ingredients can include aldehyde C16, almond oil, alpha-terpineol, verbenone, alpha-cedrene, cinnamic aldehyde, amyl cinnamic aldehyde, cinnamyl acetate, amyl salicylate, anisic aldehyde, cedrol, benzyl acetate, cinnamaldehyde, cinnamic alcohol, carvacrol, carveol, citral, citronellal, citronellol, dimethyl salicylate, eucalyptol (also known as 1,8-cineole), thujopsene, 3-thujopsanone, alpha-thujone, beta-thujone, fenchone, eugenyl acetate (e.g., isoeugenyl acetate), d-limonene, linalool, alpha-pinene, tetrahydrolinalool, ethyl cinnamate, eugenol, iso-eugenol, methyl iso-eugenol, galaxolide, geraniol, guaiacol, ionone, menthol (e.g., L-menthol), menthone, carvone (e.g., L-carvone), camphor, p-cymene, bornyl acetate, isobornyl acetate, gamma-terpinene, methyl anthranilate, methyl ionone, methyl salicylate, nerol, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin, castor oil, cedar oil, cinnamon, cinnamon oil, citronella, citronella oil, clove, corn oil, cornmint oil, cottonseed oil, garlic, garlic oil, linseed oil, mint, mint oil, thyme, peppermint, peppermint oil, spearmint, spearmint oil, rosemary, sesame, sesame oil, soybean oil, white pepper, licorice oil, wintergreen oil, star anise oil, lilac flower oil, black seed oil, grapefruit seed oil, grapefruit, lemon oil, orange oil, tea tree oil, tagete minuta oil, lavender oil, lippia javancia oil, oil of bergamot, galbanum oil, lovage oil, and combinations thereof.

Examples of essential oils can include thyme (thymol, carvacrol), oregano (carvacrol, terpenes), lemon (limonene, terpinene, phellandrene, pinene, citral), orange flower (linalool, β-pinene, limonene), orange (limonene, citral), anise (anethole, safrol), clove (eugenol, eugenyl acetate, caryophyllene), rose (geraniol, citronellol), rosemary (borneol, bornyl esters, camphor), geranium (geraniol, citronellol, linalool), lavender (linalyl acetate, linalool), citronella (geraniol, citronellol, citronellal, camphene), eucalyptus (eucalyptol), peppermint (menthol, menthyl esters), spearmint (carvone, limonene, pinene), wintergreen (methyl salicylate), camphor (safrole, acetaldehyde, camphor), bay (eugenol, myrcene, chavicol), cinnamon (cinnamaldehyde, cinnamyl acetate, eugenol), tea tree (terpinen-4-ol, cineole), cedar leaf (α-thujone, β-thujone, fenchone), geranium (Citronellol, Geraniol, guaiadiene), cornmint (Menthol, Menthone), garlic (dimethyl trisulfide, diallyl disulfide, diallyl sulfide, diallyl tetrasulfide, 3-vinyl-[4H]-1,2-dithiin), and combinations thereof.

In some aspects, the pest control composition described herein may comprise one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof, preferably selected from the group consisting of geraniol, cornmint oil, spearmint oil, peppermint oil, mint oil, rosemary oil, and combinations thereof, more preferably selected from the group consisting of geraniol, cornmint oil, spearmint oil, peppermint oil, mint oil.

The pest control composition may comprise from about 0.005% to about 30% of the one or more active ingredients, or from about 0.05% to about 25%, or from about 0.15% to about 15%, or from about 0.5% to about 12%, or from about 1% to about 10%, or from about 3% to about 8%, or from about 4% to about 7%, all by weight of the pest control composition.

In some aspects, the pest control composition may comprise about 0.005% to about 15%, or from about 0.05% to about 15%, or from about 0.15% to about 12%, or from about 0.5% to about 10%, or from about 1% to about 8%, all by weight of the pest control composition, of one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof.

In some aspects, the one or more active ingredients may comprise a synthetic pesticide. Examples of synthetic pesticides can include pyrethroids, such as bifenthrin, esfenvalerate, fenpropathrin, permethrin, cypermethrin, cyfluthrin, deltamethrin, allethrin, lambda-cyhalothrin, or the like; syngergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. In some aspects, the pest control composition may comprise less than about 10% of a synthetic pesticide, or less than about 5%, or less than about 2%, or less than about 1%, or less than about 0.5%, or less than about 0.1%, all by weight of the pest control composition. Alternatively, the pest control composition may be substantially free of a synthetic pesticide.

In some aspects, the one or more active ingredients may comprise a biopesticide. Suitable examples of biopesticides can include pyrethrum, rotenone, neem oil, and mixtures thereof.

In some aspects, the pest control composition may comprise from about 0.05% to about 15%, or from about 0.15% to about 15%, or from about 0.5% to about 12%, or from about 1% to about 10%, by weight of the composition of one or more active ingredients, wherein the one or more active ingredients is an essential oil and/or a constituent thereof or a synthetic analogue of an essential oil. The pest control composition may comprise one or more active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of geraniol, cornmint oil, peppermint oil, spearmint oil, mint oil, rosemary oil, thyme oil, lemongrass oil, citronella oil, and mixtures thereof, more preferably selected from the group consisting of geraniol, cornmint oil, spearmint oil, peppermint, mint oil, and combinations thereof.

The pest control composition may comprise a first active ingredient and a second active ingredient. Without being bound by theory, it is believed that pesticidal efficacy, such as weed control efficacy, may be improved by combining several active ingredients. In some aspects, the first active ingredient may be geraniol, and the second active ingredient may be a mint composition such as cornmint oil, spearmint oil, peppermint oil, mint oil, or combinations thereof. In some aspects, the pest control composition may comprise from about 1% to about 6% geraniol, or from about 2% to about 5%, all by weight of the pest control composition. In some aspects, the pest control composition may comprise from about 0.5% to about 4% of the mint composition, or from about 1% to about 3%, all by weight of the pest control composition. In some aspects, the pest control composition may comprise a ratio of geraniol to mint composition of from about 3:1 to about 4:1.

### Surfactant

The pest control composition may comprise one or more surfactants. The pest control composition may comprise from about 1% to about 12% of the one or more surfactants, or from about 4% to about 10%, or from about 6% to about 8%, all by weight of the pest control composition.

Surfactants can wet and disperse particles of active ingredient(s) in the composition prior to spraying, thereby enabling more uniform coverage and wetting of the target weed upon spraying. Surfactants may also function to emulsify hydrophobic active agents that are not easily solubilized in water, such as oils. Surfactants thus include various agents known to function as emulsifiers or wetting agents. Suitable surfactants can include anionic surfactants, amphoteric surfactants, zwitterionic surfactants, nonionic surfactants, cationic surfactants, or mixtures thereof.

In some aspects, at least one of the one or more surfactants may preferably be an anionic surfactant. Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the alkyl group (e.g., linear alkyl benzene sulfonates, such as dodecylbenzene sulfonate and salts thereof), alkyl sulfates and alkali metal salts thereof (e.g., sodium dodecyl sulfate), alkyl ether sulfates having from about 8 to about 22 carbon atoms in the alkyl group and about 2 to about 9 moles of ethylene oxide. Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO.

A preferred anionic surfactant is sodium lauryl sulfate or “SLS” (also known as sodium dodecyl sulfate). The pest control composition may comprise from about 4% to about 10% sodium lauryl sulfate, or from about 5% to about 8%, all by weight of the pest control composition. In some aspects, the pest control composition may comprise a surfactant consisting essentially of sodium lauryl sulfate.

Anionic surfactants may also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts of fatty acids are also known as soaps and the counter ions of the salts may be sodium, potassium, calcium, magnesium, barium, iron, ammonium and amine salts of fatty acids. Fatty acid and the salts thereof may be linear, branched, saturated, unsaturated, cyclic, or mixtures thereof. Examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Additional suitable anionic surfactants can include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Alternatively, the pest control composition may be substantially free of fatty acids, as a fatty acid may be difficult to solubilize in an aqueous composition. In particular, the pest control composition may be substantially free of lauric acid, oleic acid, stearic acid, or a combination thereof.

The pest control composition may comprise one or more active ingredients, such as one or more hydrophobic active ingredients (such as a natural oil/essential oil or a constituent or a synthetic analogue thereof), and surfactant, preferably an anionic surfactant, more preferably sodium lauryl sulfate. The weight ratio of surfactant to total active ingredient may be from about 1:3 to about 30:1, or about 1:3 to about 20:1, or about 1:1 to about 30:1, or about 1:1 to about 20:1, or about 1:1 to about 10:1, or about 1:1 to about 5:1, or about 1:3 to about 3:1, or about 1:2 to about 2:1, or about 1:1.5 to about 1.5:1, or about 1:1.2 to about 1.2:1. It has been surprisingly found that if the ratio of total (hydrophobic) active ingredient to sodium lauryl sulfate is too high, there may not be enough sodium lauryl sulfate to solubilize the (hydrophobic) active ingredient, particularly over a range of temperatures from about 5° C. to about 40° C. If the hydrophobic active ingredient is not sufficiently emulsified, then a layer of the hydrophobic ingredient, e.g., oil, may form on top of the composition, causing the composition to appear turbid. However, if the ratio of hydrophobic active ingredient to sodium lauryl sulfate is too low, then there may be too much free sodium lauryl sulfate, which may precipitate at cold temperatures.

The pest control composition may comprise an amphoteric surfactant, a zwitterionic surfactant, a nonionic surfactant, or a mixture thereof (in addition to or instead of an anionic surfactant). Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines and sultaines. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alkyl sultaines, and alkylamidoalkylenchydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280.

The pest control composition may optionally comprise one or more cationic surfactants. Suitable cationic surfactants include quaternary ammonium surfactants and amino surfactants that are positively charged at the pH of the pest control composition.

### Urea

The pest control composition may comprise from about 0.1% to about 10%, or from about 0.5% to about 8%, or from about 1% to about 6%, by weight of the pest control composition of urea. Without wishing to be bound by theory, it is believed that urea may improve the stability, availability, and/or solubility of the one or more active ingredients in the composition, thereby improving the efficacy of the composition without increasing the concentration of VOCs. Further, it is believed that urea may improve the low temperature stability of compositions containing anionic surfactants, such as SLS.

### Solvent

The pest control compositions described herein may comprise from about 0.001% to about 15% of a solvent, or from about 0.01% to about 12%, or from about 0.1% to about 10%, or from about 0.5% to about 8%, or from about 1% to about 5%, or from about 1.5% to about 4%, or from about 2% to about 3%, all by weight of the pest control composition. Liquid pest control compositions may comprise one or more solvents and water.

Suitable solvents can include alcohols, such as monohydric or polyhydric alcohols. Preferred monohydric alcohols are low molecular weight primary or secondary alcohols exemplified by ethanol, propanol, and isopropanol, preferably isopropanol. Polyhydric alcohols, such as those containing from 2 to about 6 carbon atoms and from 2 to about 6 hydroxy groups (e.g., ethylene glycol, glycerin, and 1,2-propanediol (also referred to as propylene glycol)), may also be used.

Suitable solvents also include esters. The pest control composition may comprise from about 0.005% to about 15% of one or more esters, or from about 0.05% to about 12%, or from about 0.5% to about 10%, or from about 1% to about 7%, all by weight of the pest control composition. Examples of suitable esters include triethyl citrate, diethyl citrate, monoethyl citrate, isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, PPG myristyl propionate, diglyceryl monooleate, and diglyceryl monostearate. In some aspects, the pest control composition may comprise triethyl citrate, preferably from about 1% to about 10%, or from about 4% to about 8%, all by weight of the pest control composition.

Additional solvents include lipophilic fluids, including siloxanes, other silicones, hydrocarbons, glycol ethers, glycerin derivatives such as glycerin ethers, perfluorinated amines, perfluorinated and hydrofluoroether solvents, low volatility nonfluorinated organic solvents, diol solvents, and mixtures thereof.

Suitable solvents listed under section 25(b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), isopropyl alcohol, and glycerin.

In some aspects, the pest control composition may comprise a solvent chosen from isopropanol, triethyl citrate, ethanol, glycerin, ethyl lactate, renewable versions thereof, or mixtures thereof, preferably chosen from isopropanol, triethyl citrate, and mixtures thereof. In some aspects, the pest control composition may comprise less than about 2.5% glycerin, by weight of the pest control composition, or may be substantially free of glycerin.

In some aspects, the solvent may be a C1-C4 alcohol, such as isopropyl alcohol, methanol, ethanol, or butanol. The pest control composition may comprise from about 0.5% to about 8% of a C1-C4 alcohol, or from about 1% to about 5%, or from about 1.5% to about 4%, or from about 2% to about 3%, all by weight of the pest control composition.

### pH Adjusting Agents

The pest control composition may comprise a buffer system. The buffer system may comprise one or more pH adjusting agents, such as an acid. The buffer system may comprise an acid (such as citric acid and/or acetic acid) and its conjugate base (such as a salt of citric acid and/or acetic acid). When the pest control composition comprises a buffer system, the acid may be citric acid or acetic acid and the conjugate base may be a sodium salt of the respective acid.

The pest control composition may comprise one or more pH adjusting agents. The pest control composition may comprise from about 0.0001% to about 3% of the one or more pH adjusting agent, such as a carboxylic acid or a salt thereof, e.g., citric acid or a salt thereof, or from 0.001% to about 1.5%, or from about 0.01% to about 1%, or from about 0.1% to about 0.6%, all by weight of the pest control composition. Examples of pH adjusting agents may include malic acid, citric acid, fumaric acid, humic acid, acetic acid, monosodium citrate, sodium citrate, disodium citrate, trisodium citrate, trisodium citrate dehydrate, trisodium citrate pentahydrate, sodium acetate, or combinations thereof. The pH adjusting agent may be selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof, more preferably citric acid anhydrous or citric acid monohydrate. The pH adjusting agent may be selected from the group consisting of sodium citrate, citric acid, sodium acetate, acetic acid, and combinations thereof. Carboxylic acids, such as citric acid, or salts thereof may also function as chelants.

### Hydrotropic Salt

The pest control composition may comprise one or more hydrotropic salts. As used herein, a hydrotropic salt is the salt of a monovalent, C5 to C9 organic acid. Without wishing to be bound by theory, it is believed that a hydrotropic salt, unlike an inorganic salt, will selectively partition into and consequently modify the self-assembled surfactant microstructure. Salts with fewer than five carbon atoms, such as acetic acid, are highly water soluble and have little or no impact on the surfactant self-assembled microstructure as they reside predominantly in the water phase. Inorganic salts (e.g., salts without carbon atoms) such as sodium chloride are fully water soluble and will not partition into the surfactant self-assembled microstructure. Salts with more than nine carbon atoms may act as a co-surfactant to modify the surfactant self-assembled structure into other surfactant aggregate structures. It is believed that hydrotropic salts with five to nine carbon atoms and a monovalent organic acid moiety have sufficient balance between hydrophobicity and hydrophilicity to partition into a surfactant self-assembled microstructure and can help to create lyotropic liquid crystalline microstructures. In some aspects, the composition may comprise preferably comprise a C6 to C7 hydrotropic salt. The organic moiety may be aliphatic or aromatic, saturated or unsaturated and linear or branched. The organic moiety may be unsaturated and branched. The acid moiety may be a carboxylic acid or a sulfonic acid.

Examples of monovalent, C5 to C9 organic carboxylic acids can include valeric acid, isovaleric acid, 2-methylbutiric acid, pivalic acid, beta-hydroxyvaleric acid, gamma-hydroxyvaleric acid, beta-hydroxy beta-methylbutyric acid, alpha-furoic acid, tetrahydrofuroic acid, caproic acid, dimethylbutanoic acid, sorbic acid, enanthic acid, cyclohexanecarboxylic acid, benzoic acid, salicylic acid, dimethylpentanoic acid, 2-ethyl-3-methylbutanoic acid, octanoic acid, methylheptanoic acid, dimethylhexanoic acid, ethanchexanoic acid, octenoic acid, nonanoic acid, and cinnamic acid. Examples of monovalent, C5 to C9 organic sulfonic acids can include benzene sulfonic acid, butyl monoglycol sulfonic acid, toluene sulfonic acid, xylene sulfonic acid, and cumene sulfonic acid. Examples of suitable cations for the hydrotropic salt can include sodium, potassium, calcium, magnesium, ammonium, and combinations thereof. In some aspects, the cation may be sodium and/or potassium.

In some aspects, the hydrotropic salt may be selected from potassium benzoate, ammonium benzoate, calcium benzoate, sodium benzoate, magnesium benzoate, potassium sorbate, sodium sorbate, magnesium sorbate, ammonium sorbate, calcium sorbate, calcium octanoate, potassium octanoate, sodium octanoate, and mixtures thereof.

Particularly suitable hydrotropic salts can include salts of benzoic acid, salts of sorbic acid, salts of octanoic acid, and mixtures thereof.

In some aspects, when the hydrotropic salt is a salt of benzoic acid, the pest control composition may comprise from about 1% to about 15%, or from about 3% to about 13%, or from about 5% to about 10%, of the hydrotropic salt, all by weight of the pest control composition. In some aspects, when the hydrotropic salt is a salt of sorbic acid, the pest control composition may comprise from about 1% to about 5%, or from about 1.5% to about 3%, or from about 2% to about 2.5%, of the hydrotropic salt, all by weight of the pest control composition.

In some aspects, the pest control composition may comprise a first hydrotropic salt and a second hydrotropic salt, wherein the first and second hydrotropic salts are different. In some aspects, it may be preferable to use a combination of hydrotropic salts such that total hydrotropic salt is from about 1% to about 8%, or from about 1.5% to about 6%, or from about 2% to about 4%, by weight of the pest control composition. In some aspects, the pest control composition may comprise a salt of benzoic acid and a salt of sorbic acid. When both a salt of benzoic acid and a salt of sorbic acid are used, the weight ratio of salt of benzoic acid to salt of sorbic acid may be from about 1:3 to about 3:1. It was surprisingly found that having a ratio of salt of benzoic acid to salt of sorbic acid outside of this range can lead to a microstructure that is not phase stable.

The pest control composition may comprise a ratio of total hydrotropic salt to surfactant, preferably sodium lauryl sulfate, of from about 0.15 to about 0.9, or from about 0.3 to about 0.9, or from about 0.4 to about 0.8. If the ratio of total hydrotropic salt to surfactant is too high, it is believed that the hydrotropic salt will dominate the interfacial behavior and destroy the lyotropic liquid crystalline microstructure. If the ratio of total hydrotropic salt is too low, it is believed that there may be insufficient influence to create a lyotropic liquid crystalline microstructure and the self-assembled microstructure will remain a surfactant aggregate, such as a micelle.

The pest control composition may comprise a ratio of total hydrotropic salt to active ingredient, preferably essential oil, of from about 0.15 to about 1.0, or from about 0.2 to about 1.0, or from about 0.3 to about 0.9. Without being limited by theory, it is believed that having a ratio of total hydrotropic salt to active ingredient outside of this range may interfere with the ability to form a lyotropic liquid crystal microstructure.

The pest control composition described herein may be a non-selective contact herbicide. It was surprisingly found that the addition of a hydrotropic salt such as potassium sorbate and/or sodium benzoate can boost the herbicidal activity of the composition by effectively damaging and/or inhibiting the growth of the roots, thus helping to prevent or delay regrowth of the plant. When potassium sorbate is solubilized in the composition, the potassium ions readily dissociate. It is hypothesized that elevated levels of potassium ions in the composition, when delivered to the plant and soil, may lead to cationic antagonism, thereby inhibiting the uptake of other vital nutrients like magnesium and calcium by the plant roots. Another mechanism of action hypothesized for potassium sorbate is water starving. Water starving can occur when a high salt concentration delivered outside of the root pulls water away from the root resulting in poor water uptake. When sodium benzoate is solubilized in the composition, the sodium ions readily dissociate. It is hypothesized that the free sodium ions aid in plant dehydration by retaining available water. Additionally, the sodium ions may reduce the uptake of nutrients such as potassium, magnesium, and calcium through cationic antagonism mechanisms within the plant. These disruptions of key mechanisms can result in delayed or inhibited plant growth.

While inorganic salts like sodium chloride are known to improve efficacy of some pest control compositions, it was surprisingly found that adding sodium chloride to the context of the pest control composition described herein disrupts the unique microstructure of the composition and resulted in phase separation. In some aspects, the pest control composition may be substantially free of chloride ions.

The pest control composition described herein comprises a microstructure with a hydrodynamic equivalent diameter of from about 10 nm to about 50 nm, or about 15 nm to about 45 nm, or about 22 nm to about 40 nm as measured according to Hydrodynamic Equivalent Diameter Test Method. In some aspects, it may be desirable to have a pest control composition that exhibits a hydrodynamic equivalent diameter of from about 28 nm to about 50 nm, or about 30 nm to about 45 nm, or about 32 nm to about 40 nm, as measured according to Hydrodynamic Equivalent Diameter Test Method.

The pest control composition may have a receding contact angle of less than about 21 degrees, or from about 0 to about 20 degrees, or from about 0 to about 18 degrees, or from about 0 to about 15 degrees, or from about 0 to about 13 degrees. Without being limited by theory, it is believed that by having a receding contact angle of less than about 21 degrees, the pest control composition can wet the surface of and/or stick to the surface of a target pest (e.g., the leaves and/or stems of a weed) for a longer period of time (as compared to conventional herbicides), thus allowing more contact time and/or more surface area covered by the pest control composition better allowing the pest control composition to act on the pest. It was surprisingly found that the pest control composition described herein can stick and dry onto the target surface, leaving a residue of salt crystals which is believed to help with pest control efficacy.

The pest control composition may have a pH ranging from about 4.8 to about 8.0, or from about 5.0 to about 7.5, or from about 5.5 to about 6.5. In some aspects, the pest control composition may have a pH from about 5.0 to about 6.5.

The pest control composition may be a “low VOC” composition and may comprise about 3% volatile organic compounds (VOCs) by weight or less. Alternatively, the pest control composition may comprise greater than 3% volatile organic compounds (VOCs) by weight. The pest control composition may comprise from about 3% to about 35% by weight of volatile organic compound (VOC). In some aspects, it may be desirable to keep the total level of VOCs in the pest control composition to less than or equal to about 3% by weight. VOCs can be measured according to the California Air Resources Board (CARB) Method 310 for VOC determination (May 25, 2018).

The pest control composition may be subject to fluctuating temperatures during shipping, storage, and/or use. The pest control composition may be stable (clear or translucent and a single phase) at low temperatures (i.e., from about 5° C. to about 10° C.). The pest control composition may also be stable (clear or translucent and a single phase) at 25° C. Maintaining clarity/translucency and phase stability over a range of temperatures below 25° C. may be important for pest control products because they are often stored in areas devoid of temperature control (e.g., garage or shed). In addition, it was found that the pest control composition may be stable at high temperatures (i.e., from about 50° C. to about 55° C.).

The pest control composition may have a relatively high level of clarity (i.e., low turbidity). Some consumers prefer a substantially clear or translucent product versus a product that is cloudy or murky (i.e., higher turbidity). A substantially clear or translucent composition that is a single phase may connote purity, quality, and/or that the composition is not likely to stain surfaces. In some aspects, the composition may exhibit a turbidity of from about 2 NTU to about 40 NTU, or from about 5 NTU to about 35 NTU. In some aspects, the pest control composition may exhibit a turbidity of from about 13 NTU to about 40 NTU, or from about 15 NTU to about 35 NTU, or from about 18 NTU to about 32 NTU. Turbidity of the compositions is measured with a laboratory turbidity meter as described in the Turbidity Method below.

The pest control composition may be stored outside or in a garage where it may be subject to fluctuating temperatures, such as daytime and nighttime temperature changes and/or seasonal temperature changes. The pest control composition described herein may be stable at low temperatures (i.e., from about 5° C. to about 10° C.) and at high temperatures (i.e., from about 50° C. to about 55° C.).

The pest control composition may be non-Newtonian and exhibit shear thinning behavior. Relatively low viscosity fluids are easy to spray and form droplets to coat a target surface (such as a plant); however, relatively high viscosity fluids are better able to stick to the surface. It was surprisingly found that the composition described has a viscosity that is suitable for spraying (a high shear rate event) yet at a low shear event (resting on a target pest) has a higher viscosity which is more conducive to sticking to a target pest.

The pest control composition may exhibit a first viscosity of from about 15 cP to about 1,000 cP, or from about 20 cP to about 800 cP, or from about 25 cP to about 600 cP, at a shear rate of 1 sec-1 measured at 22° C. In some aspects, the pest control composition may exhibit a first viscosity of from about 30 cP to about 1,000 cP, or from about 100 cP to about 800 cP, or from about 200 cP to about 600 cP, or from about 250 cP to about 400 cP, at a shear rate of 1 sec⁻¹ measured at 22° C. The pest control composition may exhibit a second viscosity of from about 1 cP to about 50 cP, or from about 5 cP to about 40 cP, or from about 10 cP to about 35 cP, at a shear rate of 500 sec⁻¹ measured at 22° C. The pest control composition may exhibit a first viscosity of from about 15 cP to about 1,000 cP at a shear rate of 1 sec⁻¹ measured at 22° C. and a second viscosity of from about 1 cP to about 50 cP at a shear rate of 500 sec⁻¹ measured at 22° C. In some aspects, the pest control composition may exhibit a first viscosity of from about 30 cP to about 1,000 cP at a shear rate of 1 sec⁻¹ measured at 22° C. and a second viscosity of from about 1 cP to about 50 cP at a shear rate of 500 sec⁻¹ measured at 22° C.

It was surprisingly found that the viscosity of the pest control composition thickens substantially at lower temperatures. The pest control composition may exhibit a first viscosity of from about 15 cP to about 1,500 cP, or from about 50 cP to about 1,000 cP, or from about 100 cP to about 800 cP, at a shear rate of 1 sec⁻¹ measured at 15° C. In some aspects, the pest control composition may exhibit a first viscosity of from about 430 cP to about 1,500 cP, or from about 475 cP to about 1,000 cP, or from about 500 cP to about 800 cP, at a shear rate of 1 sec⁻¹ measured at 15° C. The pest control composition may exhibit a second viscosity of from about 1 cP to about 50 cP, or from about 10 cP to about 40 cP, or from about 15 cP to about 35 cP, at a shear rate of 500 sec⁻¹ measured at 15° C. The pest control composition may exhibit a first viscosity of from about 15 cP to about 1,500 cP at a shear rate of 1 sec⁻¹ measured at 15° C. and a second viscosity of from about 1 cP to about 50 cP at a shear rate of 500 sec⁻¹ measured at 15° C. In some aspects, the pest control composition may exhibit a first viscosity of from about 430 cP to about 1,500 cP at a shear rate of 1 sec⁻¹ measured at 15° C. and a second viscosity of from about 1 cP to about 50 cP at a shear rate of 500 sec⁻¹ measured at 15° C.

The pest control composition may exhibit a ratio of the first viscosity to the second viscosity measured at 22° C. of at least 1.5, or from about 2 to about 25, or from about 5 to about 20, or from about 8 to about 18. The pest control composition may exhibit a ratio of the first viscosity to the second viscosity measured at 15° C. of at least 1.5, or from about 2 to about 30, or from about 10 to about 28, or from about 20 to about 25. The pest control composition may exhibit a ratio of the first viscosity measured at 15° C. to the first viscosity measured at 22° C. of at least 1.5, or from about 1.75 to 25, or from about 1.8 to about 20, or about 1.9 to about 12. The pest control composition may exhibit a ratio of the second viscosity measured at 15° C. to the second viscosity measured at 22° C. of at least 1.4, or from about 1.5 to 8, or from about 1.6 to about 2.5.

Without being limited by theory, it is believed that the anisotropic microstructure formed by the pest control composition described herein helps to create rheological properties of the composition which allow the composition to better adhere to and spread on a target surface yet are still compatible with spraying. At rest and low shear (e.g., 1 sec⁻¹), entropy dominates and these microstructures are randomly oriented. This can lead to increased interaction between different domains/structures, and as a result, hinder flow and lead to a higher viscosity. At higher shear rates (e.g., 500 sec⁻¹), the microstructures align their longest dimension with the flow field. This alignment can reduce the incidences of the structures colliding with one another, and as a result, lead to a lower viscosity.

### Packaging and Dispensing

Also described herein is a pest control product comprising a pest control composition disposed in a container. The pest control compositions described herein may be packaged in any suitable container, including those constructed from paper, cardboard, plastic materials, metal, and any suitable laminates. The container may store from about 50 g to about 5,000 g, or from about 2,000 g to about 5,000 g, or from about 3,000 g to about 5,000 g, or from about 50 g to about 2,000 g, or from about 50 g to about 500 g, or from about 150 g to about 400 g, or from about 200 g to about 350 g of the pest control composition. The container may store from about 400 g to about 8,000 g, or from about 500 g to about 6,000 g, or from about 1,000 g to about 5,000 g, or from about 1,500 g to about 4,000 g of the pest control composition. The weight of the pest control product, including the composition, may be selected to enable a user to comfortably manipulate and actuate the product with one hand, while providing enough composition to treat one or multiple target areas/surfaces of varying sizes, once or multiple times, e.g., multi-use product (e.g., a multi-use product).

The pest control composition may be dispensed in any number of suitable manners, such as spraying, pouring, and the like. The pest control composition may be dispensed by spraying using any number of known spray dispensers, e.g., pump-spray, trigger-spray, aerosol-spray, and the like. The spray dispenser may be attached to a plastic or metal container and may include known components, such as a dip tube, a valve, an actuator, and/or a nozzle for dispensing the composition to the environment. The valve may control flow and/or to seal the composition, such as within a pressurized plastic or metal container. The spray dispenser (e.g., powered spray wand, manual trigger spray) may be connected to the container by a tube or a hose, thereby allowing a user to hold the container in one hand and the spray dispenser in the other hand.

In the case of a pressurized container, in addition to the pest control composition, the container may comprise a propellant. Examples of suitable propellants include compressed gasses, such as nitrogen, carbon dioxide, and air; liquidized hydrocarbons, such as butane, isobutate, and propane; hydrofluoro-olefins, and mixtures thereof. The propellant may be selected from the group consisting of nitrogen, carbon dioxide, and mixtures thereof. The pressurized container may have an internal gage pressure of from about 414 kPa to about 1,100 kPa, or from about 600 kPa to about 1,000 kPa, or from about 700 kPa to about 900 kPa.

The pest control composition may be packaged in a container, such as a bottle, that is at least partially transparent or translucent. In some aspects, the container may comprise a transparent portion, such as a window. Suitable container materials that may be used can include polypropylene (PP), polyethylene (PE), polycarbonate (PC), polyamides (PA) and/or polyethylene terephthalate (PET), polyvinylchloride (PVC), and polystyrene (PS).

A transparent or translucent container or portion thereof may have a light transmittance of greater than about 25% at wavelength of about 410-800 nm. A transparent or translucent container or portion thereof may have a light transmittance of more than about 25%, or more than about 30%, or more than about 40%, or more than about 50%, or more than about 60%, or more than about 80%, or more than about 95%, in the visible part of the spectrum (approx. 410-800 nm). Alternatively, absorbency of the container may be measured as less than about 0.6 or by having transmittance greater than about 25%, where % transmittance equals:

$$\frac{1}{{10}^{absorbency}} \times 100 \%$$

For purposes of the disclosure, as long as one wavelength in the visible light range has greater than about 25% transmittance, it is considered to be transparent/translucent.

A transparent or translucent container may be desirable for housing a clear, colorless, and/or single-phase pest control composition, as such a container allows a user to view the contents of the container, which may enable the user to confirm the suitability/useableness of the composition. For example, a user may readily observe the clear, colorless, and/or a single-phase character of the composition at the time of purchase, as well as at a later time point, such as after seasonal (e.g., winter) storage, to confirm the suitability/useableness of the composition.

### Method for Making a Pest Control Composition

The present disclosure also relates to processes for making a pest control composition comprising one or more hydrotropic salt.

In some aspects, the components to form a pest control composition can be added in the following order: water, hydrotropic salt(s), surfactant(s), solvent(s), and active ingredient(s). In some aspects, pH adjusting agent(s) can be added at various steps of the process to reach the desired target pH. In some aspects, a second hydrotropic salt may be added after the addition of the active ingredient(s) and prior to adjusting the pH to the target pH.

It is believed that changing the order of addition of the formulation components may alter the rheology and/or cause degradation of certain components. In order to minimize the risk of degradation and to maintain the desired rheology, it may be preferable to add the components in the following order: water, sodium benzoate, sodium lauryl sulfate, optionally citric acid, triethyl citrate, isopropyl alcohol, active ingredient(s), trisodium citrate, and potassium sorbate. Additional citric acid may optionally be added to reach the desired target pH. In some aspects, a first portion of citric acid may be added after the surfactant to lower the pH in order to reduce the degradation of triethyl citrate. Without being limited by theory, it is believed that if the order of addition of the formulation components is modified, a pest control composition may be formed which contains degradation products such as citric acid, ethanol, sorbic acid, acetaldehyde, beta carboxylacrolein, crotonaldehyde, and/or acetone.

In some aspects, a method of forming a pest control composition can comprise the steps of:
a. mixing water, a first hydrotropic salt, and a surfactant to form a first mixture;
b. optionally mixing a first pH adjusting agent with the first mixture to reduce the pH, preferably to a pH of less than about 6.5;
c. mixing one or more solvents and one or more active ingredients with the first mixture to form a second mixture; and
d. mixing a second pH adjusting agent and an optional second hydrotropic salt with the second mixture to form a pest control composition comprising an anisotropic lyotropic liquid crystalline microstructure, wherein the pH of the pest control composition is from about 5.0 to about 6.5.

The method can be performed at ambient temperature.

In some aspects, the process for making a pest control composition may comprise the steps of: a) combining sodium lauryl sulfate, one or more active ingredient, and one or more solvent, to make an active ingredient premix: b) combining the active ingredient premix with an aqueous phase comprising water, urea (if present), one or more hydrotropic salt, and optionally, one or more pH adjusting agents, to form the pest control composition; wherein the pest control composition has a pH of from about 5.0 to about 6.5, wherein the pest control composition comprises a lyotropic liquid crystalline microstructure.

### Methods for Controlling Weeds

The present disclosure also relates to methods for controlling undesired weeds. In some aspects, the method for controlling weeds can comprise the steps of: (a) providing a pest control composition (e.g., an herbicide composition); and (b) contacting the weeds with an effective amount of the pest control composition. The pest control composition may dry on the surface of the leaves and/or stem of the weeds.

Another aspect of the present disclosure includes methods of providing one or more yard and garden benefit comprising (a) providing the present pest control composition and (b) contacting a target plant with an effective amount of the pest control composition. As used herein, the one or more yard and garden benefit may be chosen from killing plant roots and/or leaves; killing broadleaf and grassy weeds; killing weeds in landscape areas, raised beds, gardens, and cracks in pavers and/or walkways; providing visible results in one hour; providing crabgrass control; killing the entire weed (roots and leaves); helping to prevent regrowth; killing moss; killing roots in a single treatment; or combinations thereof.

The pest control composition may be applied (e.g., by spraying as an aqueous liquid) onto a target area in an amount in the range of from about 0.5 to about 40 ml/ft, alternatively from about 0.9 to about 36 ml/ft.

The pest control composition may be administered to leaves and/or stems of the target weed. When sprayed on a weed, it is believed that the pest control composition can adhere to the surface of the leaves and/or stems, resulting in burn down of the plant photosystem. It was found that after drying on the weed, the pest control composition can form a visible white precipitate comprising the hydrotropic salt on the surface of the leaves and/or stems. Without being limited by theory, it is believed that rain, moisture in the air, and/or water from sprinklers can dissolve the precipitate, allowing the salt ions to get in the soil around the weed and pull water away from the roots, thus disrupting the growth of and/or killing the roots.

Upon drying, the pest control composition may leave behind a residue comprising a crystalline structure. In a dry form, the pest control composition may comprise: a. from about 18% to about 35% by weight of the pest control composition of sodium lauryl sulfate; b. from about 9% to about 25% by weight of the pest control composition of one or more C5 to C9 hydrotropic salt; c. from about 10% to about to about 20% by weight of the pest control composition of geraniol; d. optionally from about 18% to about 35% by weight of the pest control composition of triethyl citrate and/or from about 0.1% to about 2% by weight of the composition of citric acid; wherein the composition is substantially free of water and substantially free of an alcohol selected from the group consisting of methanol, ethanol, propanol, butanol, isomers thereof, and mixtures thereof. In some aspects, the pest control composition may be applied to a pest in a dry form, such as a powder or paste, and can be dissolved by rain, moisture in the air, and/or water from sprinklers.

In a dry form, the pest control composition may comprise from about 9% to about 25% of one or more C5 to C9 hydrotropic salt, or from about 11% to about 20%, all by weight of the pest control composition.

The pest control composition, e.g., herbicide, may be used to inhibit the growth and/or development of weeds, such as for example dandelion, milk thistle, broadleaf plantain, white clover, green foxtail, redroot pigweed, yellow nutsedge, crabgrass, evening primrose, chickweed, common bermudagrass, morning glory, wild carrot, Italian ryegrass, umbrella sedge, or ivy. The pest control composition, e.g., herbicide, may be used to treat existing weeds or may be used prevent weed growth. In the latter case, the pest control composition, e.g., herbicide, may be used as a pre-emergent pest control. The pest control composition may be used for non-selective pest control.

The pest control composition, e.g., herbicide, may be used to control weeds that grow from a variety of surfaces. For example, the pest control composition, e.g., herbicide, may be sprayed on hard surfaces with openings containing dirt where weeds may be present or may develop, such as asphalt, concrete, interlocking bricks, roads, and highways. The pest control composition may be applied to vegetable gardens, lawns, golf course greens, or flower beds where weeds may be present or may develop.

The pest control composition, e.g., herbicide, may be applied as a single treatment or as multiple treatments, such as application on consecutive days or weeks.

### Method of Controlling an Arthropod Pest

The present disclosure also relates to methods for controlling undesired arthropods, such as insects. In some aspects, the method of controlling an arthropod pest may comprise the steps of: (i) providing a pest control composition (e.g., an insecticide composition); (ii) contacting a target area, surface, and/or arthropod pest with the pest control composition(s) as described herein; (iii) optionally wiping any excess pest control composition from an adjacent surface(s). The arthropod pest may be contacted with an effective amount of the pest control composition. The optional wiping of an adjacent surface(s) may provide a cleaning benefit on the surface, due to the presence of a surfactant, such as sodium lauryl sulfate, in the composition. Optionally, the adjacent surface may be left to dry, without wiping or rinsing.

The pest control composition, e.g., insecticide, may be applied as a single treatment or as multiple treatments, such as application on consecutive days or weeks.

### Examples

The following data and examples are provided to help illustrate the pest control compositions described herein. The exemplified compositions are given solely for the purpose of illustration and are not to be construed as limitations of the present invention, as many variations thereof are possible without departing from the spirit and scope of the invention. All parts, percentages, and ratios herein are by weight unless otherwise specified.

### Effect of Hydrotropic Salt on Temperature Stability and Receding Contact Angle

A series of formulas were prepared to understand the impact of hydrotropic salt on temperature stability and receding contact angle of the formulation. Samples A-L were made according to the procedure described above. Temperature stability was assessed according to the Temperature Stability method described hereafter. Receding Contact Angle was assessed according to the Receding Contact Angle (RCA) Method described hereafter.

Samples A-L were made according to the following formulas.

TABLE 1

| | A | B | C | D | E | F |
|---|---|---|---|---|---|---|
| Ingredient | (wt %) | (wt %) | (wt %) | (wt %) | (wt %) | (wt %) |
| Sodium Lauryl | 6.50 | 6.50 | 7.00 | 6.00 | 7.00 | 6.00 |
| Sulfate (SLS) | | | | | | |
| Cornmint Oil¹ | 1.00 | — | 1.00 | 1.00 | 1.00 | 1.00 |
| Geraniol² | 4.85 | 4.85 | 4.85 | 3.88 | 4.85 | 3.88 |
| Spearmint³ | — | 1.00 | — | — | — | — |
| Potassium | — | — | 0.07 | 0.02 | 0.70 | 0.20 |
| Sorbate | | | | | | |
| Sodium Benzoate | — | 0.07 | — | 0.04 | — | 0.40 |
| Urea | 5.00 | 5.00 | — | — | — | — |
| Triethyl Citrate | 6.50 | 6.50 | 7.00 | 5.50 | 7.00 | 5.50 |
| Isopropyl Alcohol | 2.70 | 3.00 | 2.70 | 2.00 | 2.70 | 2.00 |
| Citric Acid | 0.05 | 0.07 | 0.04 | 0.05 | 0.07 | 0.06 |
| Trisodium Citrate | 0.25 | 0.25 | 0.25 | 0.25 | 0.25 | 0.25 |
| DI Water | QS | QS | QS | QS | QS | QS |
| Ratio of Total | 0.00 | 0.01 | 0.01 | 0.01 | 0.10 | 0.10 |
| Hydrotropic Salt | | | | | | |
| to SLS (HS:SLS) | | | | | | |
| Ratio of Total | 0.00 | 0.01 | 0.01 | 0.01 | 0.12 | 0.12 |
| Hydrotropic Salt | | | | | | |
| to Active | | | | | | |
| Ingredient (HS:O) | | | | | | |
| Phase Stability at | Pass | Fail | Fail | Pass | Fail | Fail |
| 2 wks at 5° C. | | | | | | |
| Phase Stability at | Fail | Pass | Pass | Fail | Pass | Fail |
| 2 wks at 54° C. | | | | | | |
| Receding Contact | 21.3 | 26.3 | 26.3 | 12.6 | 14.0 | 22.3 |
| Angle (Degrees) | | | | | | |
| pH as made | 6.5 | 6.49 | 6.19 | 6.43 | 6.4 | 6.35 |
| | G | H | I | J | K | L |
| Ingredient | (wt %) | (wt %) | (wt %) | (wt %) | (wt %) | (wt %) |
| Sodium Lauryl | 6.50 | 7.00 | 6.00 | 6.50 | 6.50 | 6.50 |
| Sulfate | | | | | | |
| Cornmint Oil¹ | — | 1.00 | 1.00 | — | — | — |
| Geraniol² | 4.85 | 4.85 | 3.88 | 4.85 | 4.85 | 4.85 |
| Spearmint³ | 1.00 | — | — | 1.00 | 1.00 | 1.00 |
| Potassium | — | 2.50 | 1.00 | — | — | — |
| Sorbate | | | | | | |
| Sodium | 0.65 | — | 3.00 | 5.00 | 6.50 | 13.00 |
| Benzoate | | | | | | |
| Urea | 5.00 | — | — | 5.00 | 5.00 | 5.00 |
| Triethyl Citrate | 6.50 | 7.00 | 5.50 | 6.50 | 6.50 | 6.50 |
| Isopropyl | 3.00 | 2.70 | 2.00 | 3.00 | 3.00 | 3.00 |
| Alcohol | | | | | | |
| Citric Acid | 0.16 | 0.17 | 0.24 | 0.16 | 0.23 | 0.16 |
| Trisodium | 0.25 | 0.25 | 0.25 | 0.25 | 0.25 | 0.25 |
| Citrate | | | | | | |
| DI Water | QS | QS | QS | QS | QS | QS |
| Ratio of Total | 0.10 | 0.40 | 0.70 | 0.80 | 1.00 | 2.00 |
| Hydrotropic | | | | | | |
| Salt to SLS | | | | | | |
| (HS:SLS) | | | | | | |
| Ratio of Total | 0.11 | 0.40 | 0.80 | 0.90 | 1.11 | 2.22 |
| Hydrotropic | | | | | | |
| Salt to Active | | | | | | |
| Ingredient | | | | | | |
| (HS:O) | | | | | | |
| Phase Stability | Pass | Pass | Pass | Pass | Pass | Pass |
| at 2 wks at 5° C. | | | | | | |
| Phase Stability | Fail | Pass | Pass | Pass | Pass | Pass |
| at 2 wks at | | | | | | |
| 54° C. | | | | | | |
| Receding | 18.6 | 14.3 | 12.3 | 18.6 | 22.3 | 26.6 |
| Contact Angle | | | | | | |
| (Degrees) | | | | | | |
| pH as made | 6.5 | 6.5 | 6.2 | 6.6 | 6.5 | 7.0 |

¹Available from Ventos (Kenilworth, NJ).
²Available from BASF (Beaumont, TX).
³Available from Ventos (Kenilworth, NJ).

Table 1 shows that by properly balancing the ratio of total hydrotropic salt to surfactant, a composition can be formed that exhibits both phase stability across a range of temperatures (i.e., 5° C. to 54° C.) and a receding contact angle of less than about 21 degrees. Without being limited by theory, it is believed that a pest control composition having a receding contact angle of less than about 21 degrees will spread and wet the surface of a pest (e.g., a plant surface) more effectively and thus allows for more contact time between the composition and target pest which may help improve efficacy.

Sample A is a comparative example and is representative of in-market contact herbicides and does not contain a hydrotropic salt. Sample A exhibited a receding contact angle of 21.3 degrees and was phase stable (i.e., clear and single phase) at 5° C. but unstable (i.e., contains phase separation) at 54° C. A product comprising a phase unstable composition may be undesirable to consumers as the product may require repeated shaking before use. This can be inconvenient to a consumer and is an additional step that consumers may not perform as instructed which could impact efficacy.

Samples B, C, and D have a ratio of total hydrotropic salt to SLS (HS:SLS) and a ratio of total hydrotropic salt to active ingredient (HS:O) of 0.01. Samples B and C exhibited a receding contact angle greater than Sample A of 26.3 degrees and were not phase stable at 5° C. Sample D exhibited a receding contact angle lower than Sample A of 12.6 degrees but was phase unstable at 54° C. Samples E, F, and G have an HS:SLS ratio and HS:O ratio of 0.10. Samples E and G exhibited a receding contact angle lower than Samples A of 14.0 and 18.6 degrees, respectively. However, Samples E and F were phase unstable at 5° C. and Samples F and G were phase unstable at 54° C.

Samples H, I, and J have an HS:SLS ratio of 0.40, 0.70, and 0.80, respectively, and an HS:O ratio of 0.40, 0.80, 0.90, respectively. Samples H, I, and J were phase stable at both 5° C. and 54° C. and had a receding contact angle of less than 21 degrees. It is believed that the level of hydrotropic salt, surfactant, and essential oil of Samples H, I, and J are uniquely balanced such that the hydrotropic salt can interact with the surfactant and oil to reduce the receding contact angle (which allows the compositions to better spread and wet the surface of the pest) without negatively impacting the phase stability of the composition across a range of temperatures (i.e., 5° C. to 54° C.). Samples K and L have an HS:SLS ratio of 1.0 and 2.0, respectively, and an HS:O ratio of 1.1 and 2.2, respectively. Samples K and L were phase stable at 5° C. and 54° C.; however, the receding contact angle was greater than 21 degrees. It is believed that Samples K and L may not be able to sufficiently wet the surface of the pest.

### Effect of Hydrotropic Salt on Turbidity and Hydrodynamic Equivalent Diameter

Samples A, H, I, and J were assessed to understand the impact of hydrotropic salt on turbidity and hydrodynamic equivalent diameter. Samples A, H, I, and J were made as described above according to the formulas in Table 1. Turbidity was measured after the sample was made (T=0) and after storage at 54° C. for two weeks (T=2 wks) according to the Turbidity Method described hereafter. Hydrodynamic Equivalent Diameter was measured according to the Hydrodynamic Equivalent Diameter Test Method described hereafter.

TABLE 2

| | A | | H | | I | | J | |
|---|---|---|---|---|---|---|---|---|
| Turbidity | 1 | NTU | 12 | NTU | 20 | NTU | 9 | NTU |
| at 25° C., T = 0 | | | | | | | | |
| Turbidity | >1000 | NTU | 11 | NTU | 30 | NTU | 18 | NTU |
| at 54° C., T = 2 wks | | | | | | | | |
| Hydrodynamic | 5.9 | nm | 27.0 | nm | 35.5 | nm | 23.6 | nm |
| Equivalent Diameter | | | | | | | | |

Sample A at 25° C. T=0 exhibited low turbidity (1 NTU) indicating that the sample is very clear in appearance. Samples H, I, J at 25° C., T=0 exhibited a turbidity of 12 NTU, 20 NTU, and 9 NTU, respectively. The turbidity of Samples H, I, and J is indicative of a microstructure presence in the samples. Sample A at 54° C. T=2 wks exhibited a high turbidity of greater than 1,000 NTU, indicating the presence of product opacity and instability. In contrast, Samples H, I, J show either no increase or 2× increase in turbidity when compared to the corresponding sample at 25° C., but the samples maintain their translucent stable appearance.

Sample A shows a small hydrodynamic equivalent diameter of only 5.9 nm which would only have a minimal effect on scattering light as indicated by the low NTU value. In contrast, Samples H, I and J exhibited a hydrodynamic equivalent diameter of 27.0 nm, 35.5 nm, and 23.6 nm, respectively. These results indicate that larger structures are being created within Samples H, I, and J, which influence the refraction of light resulting in the higher NTU values. Without being limited by theory, it is believed that the larger hydrodynamic equivalent diameter of Samples H, I, and J (as compared to Sample A) are a result of a microstructure being created due to the presence of the hydrotropic salts.

### Viscosity

Samples A, H, I, and J were further assessed to understand the impact of hydrotropic salt on viscosity as a function of temperature and shear rate. Samples A, H, I, and J were made as described above according to the formulas in Table 1. Viscosity was measured according to the Viscosity Test Method described hereafter.

TABLE 3

| | |
|---|---|
| Shear | Viscosity (cP) |

| Temp | Rate | Sample | Sample | Sample | Sample |
|---|---|---|---|---|---|
| (° C.) | (sec⁻¹) | A | H | I | J |
| 22 | 1 | 7.0 | 27.7 | 287.0 | 9.2 |
| 22 | 500 | 6.8 | 8.8 | 16.0 | 6.8 |
| 15 | 1 | 10.0 | 427.0 | 569.0 | 9.7 |
| 15 | 500 | 8.7 | 29.5 | 26.1 | 8.9 |

It was found that the viscosity of Sample A, which has no hydrotropic salt, has little dependency on shear rate or temperature. It was surprisingly found that Sample I exhibited a relatively strong dependency of viscosity on both temperature and shear rate. Without being limited by theory, it is believed that Sample I comprises a unique microstructure that creates temperature dependent and sheer thinning behavior. It is believed that temperature and/or shear rate dependent viscosity may be advantageous for stability and spraying characteristics of a pest control composition.

There are several methods for identifying the surfactant microstructure of a composition. For example, Cryo-TEM microscopy is a useful tool to qualitatively identify structures such as micelles and lyotropic liquid crystals and provides a snapshot of the surfactant microstructure in the particular field of view of the sample. Deuterium (²H) NMR spectroscopy can be used to quantitatively determine the spatially averaged lyotropic liquid crystal microstructure throughout the sample.

Using Cryo-TEM, it was found that Samples H, I, and J comprise lyotropic liquid crystalline microstructures and that Sample A comprises surfactant aggregate micelles.

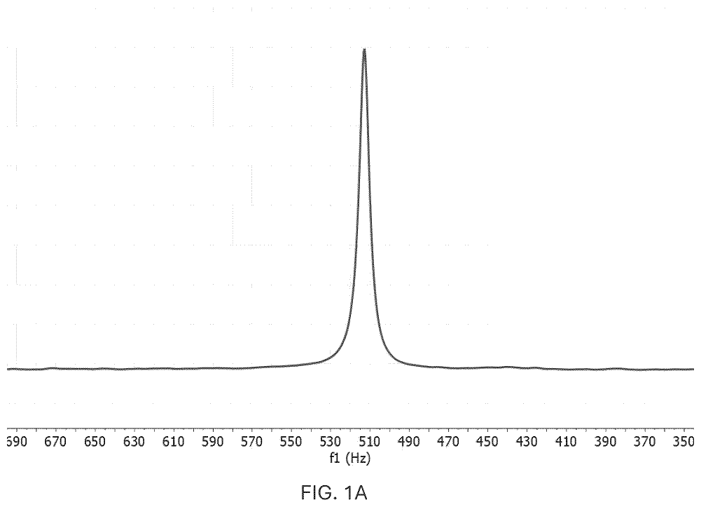

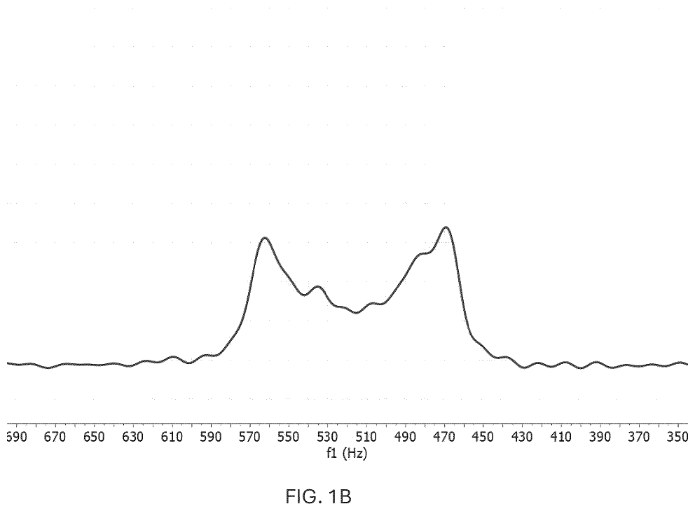

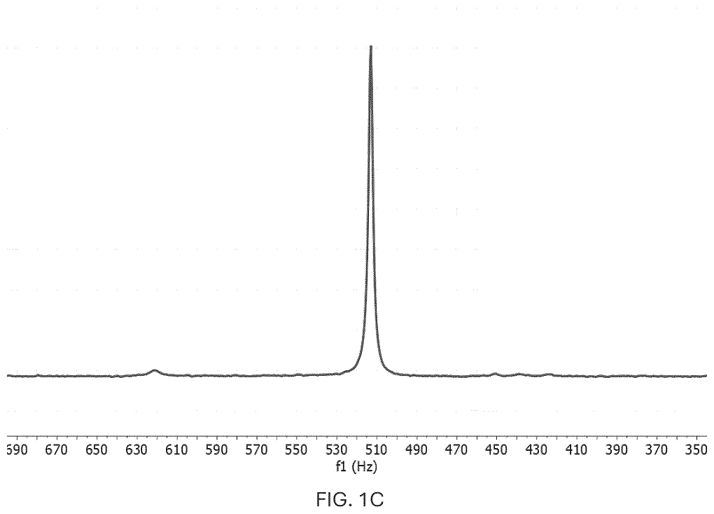

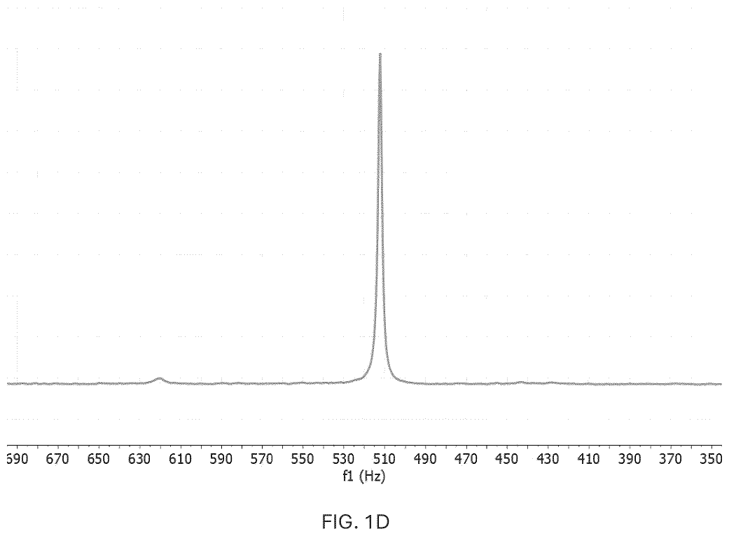

FIGS. 1A-1D show the ²H NMR spectra for Samples H, I, J, and A, respectively, as determined by the ²H NMR Method. FIG. 1A shows the ²H NMR spectrum of Sample H, which contains potassium sorbate, cornmint, and geraniol, showing the water peak exhibits a width encompassing 90% of the area of the entire water signal of 32.2 Hz, indicating the spatially averaged microstructure present is an isotropic lyotropic liquid crystalline microstructure.

FIG. 1B shows the ²H NMR spectrum of Sample I, which contains sodium benzoate, potassium sorbate, geraniol, and cornmint oil, showing the water peak exhibits a width encompassing 90% of the area of the entire water signal of 114.0 Hz. In particular, the ²H NMR spectrum for Sample I shows two local maxima (i.e., quadrupolar splitting). The ²H NMR spectrum for Sample I indicates that the spatially averaged microstructure present is an anisotropic lyotropic liquid crystalline microstructure.

FIG. 1C shows the ²H NMR spectra of Sample J, which contains sodium benzoate and geraniol, showing a water peak having a width encompassing 90% of the area of the entire water signal of 12.7 Hz, indicating the spatially averaged microstructure present is an isotropic lyotropic liquid crystalline microstructure.

FIG. 1D shows the ²H NMR spectra of Sample A, which contains no hydrotropic salt, showing the water peak exhibits a width encompassing 90% of the area of the entire water signal of 11.9 Hz, indicating the presence of an isotropic microstructure.

It was surprisingly found that when both sodium benzoate and potassium sorbate are combined with geraniol and cornmint oil, an anisotropic lyotropic liquid crystalline microstructure can be created. It was unexpectedly found that this microstructure provides the composition with rheological, adhesion, and wettability properties which allows the composition to better stick to and spread on the surface of a pest (e.g., a plant leaf or stem), thus improving the composition's efficacy, without the use of traditional polymers.

In some aspects, the pest control composition described herein may be substantially free of a polymer. Examples of polymers include corn gluten meal, alpha-cyclodextrin, beta-cyclodextrin, carboxymethyl cellulose, carob gum, carrageenan, cellulose, cellulose acetate, cellulose pulp, regenerated cellulose, citrus pectin, dextrin, gamma-cyclodextrin, gelatin, gellan gum, guar gum, gum arabic, gum tragacanth, hydroxyethyl cellulose, hydroxypropyl cellulose, hydroxypropyl methyl cellulose, maltodextrin, methylcellulose, pectin, sodium alginate, sodium carboxymethyl cellulose, soy protein, soybean meal, soybean flour, walnut flour, wheat flour, and xanthan gum.

Without being limited by theory, it is believed that a composition that exhibits a water peak having a width encompassing 90% of the area of the entire water signal of about 50 Hz or more can more effectively deliver the active ingredient(s) and salt(s) to the surface of a pest. It is believed that the actives in the pest control composition described herein have improved mobility within the surfactant structure and are therefore more bioavailable to act on the pest.

It is believed that the anisotropic lyotropic liquid crystalline microstructure of the present pest control composition can provide a carrier system for ingredients to be more effectively delivered by an oil and/or water phase. This microstructure may act to help deliver the active ingredients which may be dissolved within their hydrophobic regions. Without being limited by theory, it is believed that as the liquid pest control composition described herein begins to dry on the surface of a pest, the lyotropic liquid crystals will better deposit on the surface, and thus more efficiently deliver the active ingredients trapped within them.

Particularly suitable pest control compositions may exhibit a water peak in a ²H spectrum having a width encompassing 90% of the area of the entire water signal of about 50 Hz or more, or from about 50 Hz to about 250 kHz, or from about 50 Hz to about 1 kHz, or from about 75 Hz to about 500 Hz, or from about 90 Hz to about 300 Hz, or from about 100 Hz to about 250 Hz, or from about 110 Hz to about 200 Hz, as measured according to the ²H NMR Method.

### Additional Formulation Examples

When liquid formulations according to the present disclosure are applied to a target pest and allowed to dry, the formulations may leave behind a dried pest control composition or residue. Alternatively, formulations according to the present disclosure may be applied as a dry composition, such as a powder or a paste. Table 4 includes a range of possible dry formulations of pest control compositions according to the disclosure.

TABLE 4

| | M | N | O | P |
|---|---|---|---|---|
| | (wt %) | (wt %) | (wt %) | (wt %) |
| Sodium Lauryl | 30.9% | 29.0% | 27.4% | 22.3% |
| Sulfate | | | | |
| Cornmint Oil | 4.4% | 4.8% | 5.7% | — |
| Geraniol | 21.4% | 18.8% | 22.2% | 16.6% |
| Potassium Sorbate | 11.0% | 4.8% | 4.6% | 0.0% |
| Sodium Benzoate | — | 14.5% | 13.7% | 17.2% |
| Urea | — | — | — | 20.7% |
| Triethyl Citrate | 30.9% | 26.6% | 25.1% | 22.3% |
| Citric Acid | 0.2% | 0.2% | 0.2% | 0.1% |
| Trisodium Citrate | 1.1% | 1.2% | 1.1% | 0.9% |

### Test Methods

### Viscosity Test Method

Viscosity as a function of temperature and shear rate is measured using a suitable rheometer such as a Discovery HR 30 (available from TAR Instruments, New Castle, Del.) or equivalent fitted with a 40 mm stainless steel 1 degree cone and plate geometry. The rheometer with geometry is calibrated according to manufactures instructions prior to measurements. Samples are loaded, trimmed and fitted with a solvent trap to minimize evaporation. Samples are brought to within ±0.5° C. of target temperature and subsequently equilibrated at zero shear rate and ±0.5° C. of target temperature for two minutes. The sample is sheared at 1 sec⁻¹ for two minutes with viscosity data recorded every second and the viscosity at target temperature and a shear rate of 1 sec⁻¹ is the average of the last thirty data points recorded. The sample is subsequently sheared at a rate of 500 sec⁻¹ for two minutes with viscosity data collected every second and the viscosity at target temperature and a shear rate of 500 sec⁻¹ is the average of the last 30 data points recorded.

### pH Test Method

pH is measured using a standard pH meter such as, for example, a Beckman Coulter model PHI1410 pH meter equipped with a general-purpose probe (manufactured by Beckman Coulter, Brea, California, U.S.A.). The pH meter is calibrated according to the manufacturer's instructions. Measurements are performed after storing the compositions at room temperature (approximately 23° C.±2° C.) for approximately 24 hours.

### Hydrodynamic Equivalent Diameter Test Method

Dynamic light scattering (DLS) is used to measure particle size using a Malvern Zetasizer Nano ZEN3600 system (www.malvern.com) with a He—Ne laser 633 nm, or equivalent. The autocorrelation function is analyzed using the Zetasizer Software provided by Malvern Instruments, which determines the effective hydrodynamic radius, using the Stokes-Einstein equation:

$$D = \frac{{k}_{B} T}{6 πη R}$$

where, k_{B} is the Boltzmann Constant, T is the absolute temperature, η is the viscosity of the medium, D is the mean diffusion coefficient of the scattering species, and R is the hydrodynamic radius of particles.

Particle size (i.e. hydrodynamic radius) is obtained by correlating the observed speckle pattern that arises due to Brownian motion and solving the Stokes-Einstein equation, which relates the particle size to the measured diffusion constant, as is known in the art.

The measurement angle is 173° and a refractive index of 1.46 is used for surfactant aggregate structures. The count rate for the measurement is between 200-400 kcps. All samples are kept at 25° C., unless otherwise specified.

For each sample composition, two specimen replicates are measured in this way, and the arithmetic mean of the resulting Z-average values is reported as the Hydrodynamic Equivalent Diameter in nanometers (nm) to the nearest 0.1 nm.

### Turbidity Method

A turbidimeter is used to measure the turbidity of the compositions. A suitable turbidimeter is the Hach 2100Q/2100Qis (Hach Company, Loveland, CO, USA), or equivalent. This instrument measures the turbidity of liquids in Nephelometric Turbidity Units (NTU). The method of measuring turbidity is described in detail in the following reference: Hach 2100Q and 2100Qis User Manual, Edition 6, August 2021, from the Hach Company. If a sample is not homogenous prior to analysis, the sample is repeatedly inverted until it appears homogenous and is then poured into an analyte vile for measurement.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Temperature Stability

Samples are prepared by combining all ingredients in a 4-ounce glass vial at ambient conditions (25 deg. C). The sample is mixed and, five minutes after mixing is completed, the sample is observed for initial stability.

Cold temperature stability is measured by filling a 4-ounce glass vial with a sample composition. The vial is sealed and stored at 5° C. for two weeks. The vial is then moved to a 25° C. environment and stored for 10 to 12 hours. The vials are then visually observed for phase stability (and may be assessed for turbidity using the Turbidity Method described above). Phase instability is determined when more than one phase is visually apparent, such as a top hazy/milky phase separated from a clear bottom phase or a clear top phase that is separated from a bottom hazy/milky phase. If phase instability is observed, the sample is rated as a “fail” (F) and if no phase instability is observed, the is rated as a “pass” (P), for the specified time point.

Hot temperature stability is measured by filling a 4-ounce glass vial with a sample composition. The vial is sealed and stored at 54° C. two weeks. The vial is then moved to a 25° C. environment and stored for 10 to 12 hours. The vials are then visually observed for phase stability (and may be assessed for turbidity using the Turbidity method described above). Phase instability is determined when more than one phase is visually apparent, such as a top hazy/milky phase separated from a clear bottom phase or a clear top phase that is separated from a bottom hazy/milky phase. If phase instability is observed, the sample is rated as a “fail” (F) and if no phase instability is observed, the sample is rated as a “pass” (P), for the specified time point.

### Receding Contact Angle (RCA) Method

The receding angle (receding contact angle, RCA) is the contact angle between a liquid and a solid that has already been wetted with the liquid, which occurs in the course of dewetting. In this method, the contact angle between a droplet of sample composition and a horizontal teflon-coated substrate is measured as the volume of the droplet decreases, facilitating liquid retreat from a surface that has already be wetted with the composition. Specifically, a pump is used to dispense 2 to 6 μL of sample composition onto a teflon-coated slide at 1.4 μL/s through a 27-ga blunt-tipped needle, at which point the pump is reversed, and the droplet is pulled by suction back into the needle, reducing its volume toward zero. This entire process is captured in the plane of the slide with a camera interfaced with suitable magnification and suitable lighting and contrast to elucidate the junction between droplet of composition, teflon substrate, and surrounding air. Analysis of resulting images is then used to measure the contact angle, often digitally or via the use of image analysis procedures.

Exemplary suitable apparatus for measuring RCA is a USB 3 Based Point Grey Flycapture monochrome 500 fps camera, Fluid dispense Auto syringe, auto position tip Z, Navitar 4× lens, LED back light, and FTA 1000 Controller Electric Box, or equivalents. A standard image-analysis check can be performed prior to data collection by, for example using idealized droplet profiles of “combo calibration device” (Combo Calibration Device ramé-hart instrument co. p/n 100.27-37-31-C). In this calibration device, calibrated contact angles should be as follows (±2°) A: 30° B: 60° C.: 90° D: 120°.

Continuing with the exemplary procedure, a syringe is filled with the sample, a Grey Flat tipped needle-27G OD 0.406 mm (about 0.02 in) attached, and the syringe clamped into the dispenser. A Teflon slide should be cleaned thoroughly with Dawn dish detergent and water; then dried with ethanol and nitrogen gas. The slide is binder clipped to a glass slide to ensure a flat surface. The FTA32 software settings should be set to the following:
Images before trigger: 20
Image period before trigger(s): 0.05
Total time before trigger: 1
Images after trigger: 500
Initial period after trigger(s): 0.05
Post-trigger period multiplier: 1
Last period after trigger: 0.05
Total time after trigger: 25
Camera Frame Rate: 100
Pump rate: 1.4 μL/s

Pump out liquid until the droplet is 2-6 μL in volume. Allow a few seconds for the droplet to settle on the slide, then click the pump in button to uptake the liquid. Be sure to not let the tip of the needle leave the droplet. The movie will load into the analysis software. Select the corners of the droplet with a right click and select “Store and reuse this baseline” in the Contact Angle tab. Then click “Cineloop.” Export results to Excel. If there are any extreme spikes in the contact angle or volume values, advance to that image, reselect the corners, and create a new baseline. To determine the RCA, graph the volume and contact angle over time. The contact angle, as the volume approaches 0, is the receding contact angle.

In like fashion, the receding contact angle of a total of three replicate specimens of the sample composition are analyzed. The average (arithmetic mean) of the measured receding contact angles is calculated and reported as the Receding Contact Angle to the nearest 0.1 degree.

### ²H NMR Method

The ²H NMR method is used to establish the frequency width at 90% area of the entire water signal for a sample composition of interest. The method relies on the natural abundance of deuterium present in the sample composition, and deuterium quadrupole splitting of the water peak is used as a probe for anisotropy in the composition, as described in T. M. Ferreira, D. Bernin, and D. Topgaard, “NMR Studies of Nonionic Surfactants,” Annual Reports on NMR Spectroscopy, Volume 79, Chapter 3, which is incorporated herein in its entirety. In turn, the width at 90% area of the water signal is a means of measuring the width of quadrupolar splitting and degree of splitting in the water peak, thereby indicating a spatially averaged anisotropy in the sample composition.

A high-field NMR magnet of sufficient resolution to discriminate deuterium quadrupole splitting values of 10 Hz or greater is required to perform this analysis. A sample of interest is directly pipetted from its original container into glass NMR tubes consistent with the bore size of the magnet and probe utilized. The NMR tube containing the sample composition is capped and is allowed to equilibrate in the glass tube for 24 hours at 23° C.±2° C. The NMR experiment is performed without spinning. The magnet is tuned and matched to minimal impedance. Shimming is performed on-axis on ¹H and optimized to maximal FID (free induction decay) area. The ²H 90° pulse width is calibrated and 2048 scans of a single 90° pulse experiment with a recycle delay of 3 seconds is acquired at 23° C.±2° C. The sweep width is 130 ppm. Total FID data points (TD) are optimized to allow for full decay of the FID avoiding excessive collection of noise. (TD is approximately 2× the length of the fully decayed FID.) If the acquired FID is less than 65536 points, the data are zero filled to 65536 points. One (1) Hz line broadening is applied prior to Fourier transform. Appropriate phase correction and baseline correction are applied to the spectrum.

The location of the water peak in ppm for deuterium closely coincides with the water peak ppm in the proton spectrum. For the compositions described herein, the location of the water peak is typically found between 4.7+/−0.5 ppm at 25° C. The presence of quadrupole splitting in the form of a doublet or a smeared doublet/amorphous broadening centered about the location of the isotropic water peak indicates the presence of an oriented microstructure domain large enough to imprint a residual anisotropy of the water rotational motion on a microsecond time scale. Confirmation of the location of the isotropic water peak can be demonstrated by utilizing an external standard capillary of water in the NMR tube and observing the location of the isotropic water peak.

The entire water peak is then identified with the understanding that it may or may not exhibit partial or full splitting. (Some very weak peaks from the natural deuterium abundance of other ingredients in the composition may be discernible but are neglected in this analysis.) The horizontal axis is then transformed from the more familiar ppm scale to frequency (Hz). The water peak is then functionally integrated along the frequency axis to create effectively a cumulative intensity function—that is, corresponding to the water peak, a plot of percent intensity of the ²H signal versus frequency. From this peak integral function, the width in frequency (Hz) between 5% and 95% of peak area is determined and reported to the nearest 0.1 Hz as the width encompassing 90% of the area of the entire water signal of the sample composition.

### Combinations

Paragraph A. A pest control composition comprising:
a. from about 4% to about 10% by weight of the pest control composition of sodium lauryl sulfate;
b. one or more C5 to C9 hydrotropic salt;
c. from about 1% to about 10% by weight of the pest control composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof;
d. from about 1% to about 5% by weight of the pest control composition of a solvent, wherein the solvent is a C1-C4 alcohol; and
e. from about 60% to about 95% by weight of the pest control composition of water;
wherein the pest control composition has a pH of from about 5.0 to about 6.5;
wherein the pest control composition comprises an anisotropic lyotropic liquid crystalline microstructure.

Paragraph B. The pest control composition of Paragraph A, wherein the one or more hydrotropic salt comprises a first hydrotropic salt and a second hydrotropic salt, wherein the first hydrotropic salt and the second hydrotropic salt are different.

Paragraph C. The pest control composition of Paragraph B, wherein the first hydrotropic salt is a salt of benzoic acid, and the second hydrotropic salt is a salt of sorbic acid.

Paragraph D. The pest control composition of Paragraph C, wherein a ratio of the first hydrotropic salt to the second hydrotropic salt is about 3:1.

Paragraph E. The pest control composition according to any of Paragraphs A-D, wherein the anisotropic lyotropic liquid crystalline microstructure comprises a lamellar phase, a hexagonal phase, or a combination thereof.

Paragraph F. The pest control composition according to any of Paragraphs A-E, wherein the pest control composition exhibits a water peak in a ²H spectrum having a width encompassing 90% of the area of the entire water signal of about 50 Hz or more, as determined by the ²H NMR Method, preferably from about 50 Hz to about 250 kHz, more preferably from about 50 Hz to about 1 kHz, even more preferably from about 75 Hz to about 500 Hz.

Paragraph G. The pest control composition according to any of Paragraphs A-F, wherein the water peak in a ²H spectrum comprises two or more local maxima.

Paragraph H. The pest control composition according to any of Paragraphs A-G, wherein the pest control composition is substantially free of synthetic pesticides, mineral oil, colorants, polymers, or a combination thereof.

Paragraph I. The pest control composition according to any of Paragraphs A-H, wherein the pest control composition exhibits a receding contact angle of less than about 21 degrees, preferably from about 0 to about 20 degrees, more preferably from about 0 to about 15 degrees, even more preferably from about 0 to about 13 degrees.

Paragraph J. The pest control composition according to any of Paragraphs A-I, wherein the composition comprises from about 1% to about 8% by weight of the composition of the one or more hydrotropic salt.

Paragraph K. The pest control composition according to any of Paragraphs A-J, wherein one or more active ingredients comprises geraniol and a mint composition chosen from cornmint, spearmint, peppermint, mint oil, or combinations thereof.

Paragraph L. The pest control composition according to Paragraph K, wherein the pest control composition comprises a ratio of geraniol to the mint composition of from about 3:1 to about 4:1.

Paragraph M. The pest control according to any of Paragraphs A-L, wherein the pest control composition is non-Newtonian.

Paragraph N. The pest control composition according to any of Paragraphs A-M, wherein the pest control composition exhibits a turbidity of from about 2 NTU to about 40 NTU, preferably from about 13 NTU to about 40 NTU.

Paragraph O. The pest control composition according to any of Paragraphs A-N, wherein the pest control composition comprises about 3% volatile organic compounds (VOCs) by weight or less.

Paragraph P. The pest control composition according to any of Paragraphs A-O, wherein the pest control composition exhibits a first viscosity of from about 30 cP to about 1,000 cP at a shear rate of 1 sec⁻¹ measured at 22° C. and a second viscosity of from about 1 cP to about 50 cP at a shear rate of 500 sec⁻¹ measured at 22° C.

Paragraph Q. The pest control composition of according to any of Paragraphs A-P, wherein the pest control composition exhibits a first viscosity of from about 430 cP to about 1,500 cP at a shear rate of 1 sec⁻¹ measured at 15° C. and a second viscosity of from about 1 cP to about 50 cP at a shear rate of 500 sec⁻¹ measured at 15° C.

Paragraph S. A method of controlling one or more weeds comprising the steps of: (i) providing the pest control composition according to any of Paragraphs A-Q; and (ii) contacting the one or more weeds with the pest control composition.

Paragraph T. The method of Paragraph S, wherein the pest control composition is a contact herbicide.

Paragraph U. The method of Paragraph T, wherein the pest control composition disrupts root growth of the one or more weeds.

Paragraph A1. A method of making a pest control composition comprising the steps of:
a. mixing water, a first hydrotropic salt, and a surfactant to form a first mixture;
b. optionally mixing a first pH adjusting agent with the first mixture to reduce the pH, preferably to a pH of less than about 6.5;
c. mixing one or more solvents and one or more active ingredients with the first mixture to form a second mixture; and
d. mixing a second pH adjusting agent and an optional second hydrotropic salt with the second mixture to form a pest control composition comprising an anisotropic lyotropic liquid crystalline microstructure, wherein the pH of the pest control composition is from about 5.0 to about 6.5.

Paragraph A2. The method of Paragraph A1, wherein the method is performed at ambient temperature.

Paragraph A3. The pest control composition according to any of Paragraphs A1-A2, wherein the pest control composition exhibits a first viscosity of from about 30 cP to about 1,000 cP at a shear rate of 1 sec⁻¹ measured at 22° C. and a second viscosity of from about 1 cP to about 50 cP at a shear rate of 500 sec⁻¹ measured at 22° C.

Paragraph A4. The pest control composition according to any of Paragraphs A1-A3, wherein the pest control composition exhibits a first viscosity of from about 430 cP to about 1,500 cP at a shear rate of 1 sec⁻¹ measured at 15° C. and a second viscosity of from about 1 cP to about 50 cP at a shear rate of 500 sec⁻¹ measured at 15° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pest control composition comprising:
a. from about 4% to about 10% by weight of the pest control composition of sodium lauryl sulfate;
b. one or more C5 to C9 hydrotropic salt;
c. from about 1% to about 10% by weight of the pest control composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof; and
d. from about 60% to about 95% by weight of the pest control composition of water;
wherein the pest control composition exhibits a water peak in a ²H spectrum having a width encompassing 90% of the area of the entire water signal of about 50 Hz or more, as determined by the ²H NMR Method.

2. The pest control composition of claim 1, wherein the one or more hydrotropic salt comprises a first hydrotropic salt and a second hydrotropic salt, wherein the first hydrotropic salt and the second hydrotropic salt are different.

3. The pest control composition of claim 2, wherein the first hydrotropic salt is a salt of benzoic acid and the second hydrotropic salt is a salt of sorbic acid.

4. The pest control composition of claim 3, wherein a ratio of the first hydrotropic salt to the second hydrotropic salt is about 3:1.

5. The pest control composition of claim 1, wherein the water peak in a ²H spectrum comprises two or more local maxima.

6. The pest control composition of claim 1, wherein the pest control composition has a pH of from about 5.0 to about 6.5.

7. The pest control composition of claim 1, wherein the pest control composition is substantially free of synthetic pesticides, mineral oil, colorants, polymers, or a combination thereof.

8. The pest control composition of claim 1, wherein the pest control composition exhibits a receding contact angle of less than about 21 degrees.

9. A pest control composition comprising:
a. from about 4% to about 10% by weight of the pest control composition of sodium lauryl sulfate;
b. one or more C5 to C9 hydrotropic salt;
c. geraniol;
d. a mint composition chosen from cornmint, spearmint, peppermint, mint oil, or combinations thereof; and
e. from about 60% to about 95% by weight of the pest control composition of water;
wherein the pest control composition has a pH of from about 5.0 to about 6.5; and
wherein the pest control composition exhibits a water peak in a ²H spectrum having a width encompassing 90% of the area of the entire water signal of about 50 Hz or more, as determined by the ²H NMR Method.

10. The pest control composition of claim 9, wherein the composition comprises from about 1% to about 8% by weight of the composition of the one or more hydrotropic salt.

11. The pest control composition of claim 9, wherein the pest control composition comprises from about 1 to about 6% geraniol by weight of the pest control composition.

12. The pest control composition of claim 9, wherein the pest control composition comprises a ratio of geraniol to the mint composition of from about 3:1 to about 4:1.

13. The pest control composition of claim 9, wherein the pest control composition is non-Newtonian.

14. A pest control composition comprising:
a. from about 4% to about 10% by weight of the pest control composition of sodium lauryl sulfate;
b. one or more C5 to C9 hydrotropic salt;
c. from about 1% to about 10% by weight of the pest control composition of one or more active ingredients selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof;
d. from about 1% to about 5% by weight of the pest control composition of a solvent, wherein the solvent is a C1-C4 alcohol; and
e. from about 60% to about 95% by weight of the pest control composition of water;
wherein the pest control composition has a pH of from about 5.0 to about 6.5;
wherein the pest control composition comprises an anisotropic lyotropic liquid crystalline microstructure.

15. The pest control composition of claim 14, wherein the one or more hydrotropic salts comprises a first hydrotropic salt and a second hydrotropic salt, wherein the first hydrotropic salt and the second hydrotropic salt are different.

16. The pest control composition of claim 15, wherein the first hydrotropic salt is a salt of benzoic acid and the second hydrotropic salt is a salt of sorbic acid.

17. The pest control composition of claim 14, wherein at least one of the one or more active ingredients is geraniol.

18. A method of controlling one or more weeds comprising the steps of: (i) providing the pest control composition of claim 1; and (ii) contacting the one or more weeds with the pest control composition.

19. The method of claim 18, wherein the pest control composition is a contact herbicide.

20. The method of claim 19, wherein the pest control composition disrupts root growth of the one or more weeds.
